(19) United States
(12) Patent Application Publication
(10) Pub. No.: US 2015/0172433 A1
(43) Pub. Date: Jun. 18, 2015

(54) METHOD, SYSTEM AND MOBILE TERMINAL FOR CONNECTION TO A PUBLIC NETWORK

(71) Applicant: Symbio Finland OY, FI-33210 Tampere (FI)

(72) Inventor: Juha-Matti Liukkonen, Helsinki (FI)

(21) Appl. No.: 14/407,948

(22) PCT Filed: Jun. 14, 2013
(86) PCT No.: PCT/FI2013/050654

§ 371 Date: Dec. 13, 2014

(30) Foreign Application Priority Data
Jun. 15, 2012 (FI) 20125671

(51) Int. Cl. H04M 1/60; H04W 4/00; H04W 76/02; H04W 88/08; H04L 29/08

(52) U.S. Cl. CPC H04M 1/6075; H04W 88/08; H04L 67/12; H04W 76/02; H04W 4/008

(57) ABSTRACT

The telecommunication network has a mobile terminal with functionality for providing wireless access to a public network via an access point and a connector for connecting to a hands-free unit, a data system and a public network. The mobile terminal is connected to said hands-free unit and automatically connecting the data system of the car to the mobile terminal upon the connection of the mobile terminal to the hands-free unit. The mobile terminal connects the data system to the public network over a wireless data exchange connection used by the mobile user terminal for wireless access to the public network.

### TECHNICAL FIELD

The invention is concerned with a method, system and a mobile terminal for connection to a public network. The invention is implemented in a telecommunication network that comprises a public network, a mobile terminal, and a data system of a vehicle.

### BACKGROUND

The Internet is a global system of interconnected computer networks that use the standard Internet protocol suite to serve billions of users worldwide. It is a network of networks that consists of millions of private, public, academic, business, and government networks, of local to global scope, that are linked by a broad array of electronic, wireless and optical networking technologies. The Internet carries an extensive range of information resources and services, such as the inter-linked hypertext documents of the World Wide Web (WWW) and the infrastructure to support e-mail.

Internet access is the means by which individual terminals, computers, mobile devices, and local area networks are connected to the global Internet. There is no common or general means for access and usage. Each network sets its own standards. Internet access is usually sold by Internet Service Providers (ISPs) that use many different technologies offering a wide range of data rates to the end user. Access ISPs directly connect clients to the Internet using copper wires, wireless or fiber-optic connections.

Earlier most Internet access was from personal computers and workstations directly connected to local area networks or from dial-up connections using modems and analog telephone lines but today many consumers have switched away from dial-up to dedicated connections.

In addition to access from home, school, and the workplace, Internet access may be available from public places such as libraries and Internet cafes, where computers with Internet connections are available. Some libraries provide stations for connecting users' laptops to local area networks (LANs). There are wired and wireless LANs.

A wireless local area network (WLAN) includes an access point through which it can be wirelessly linked to the wider internet. Most modern WLANs are based on IEEE 802.11 standards, marketed under the Wi-Fi brand name.

Individual homes and businesses therefore often use Wi-Fi technology to connect laptops and smart phones to the Internet through an access point area (also called hotspot area) that is covered by a Wireless LAN (Local Area Network) signal. An access point in such an area is called a WiFI hotspot. Wi-Fi hotspots may be found in coffee shops and various other public establishments, such as hotels, shops, airports or any public area with a high concentration of potential users, such as business travelers, students etc.

Wi-Fi is a popular technology that allows an electronic device to exchange data wirelessly (using radio waves) over a computer network, including high-speed Internet connections. Wi-Fi is a trademark of the Wi-Fi Alliance. The Wi-Fi Alliance defines Wi-Fi as any “wireless local area network (WLAN) products that are based on the Institute of Electrical and Electronics Engineers' (IEEE) 802.11 standards”. However, since most modern WLANs are based on these standards, the term “Wi-Fi” is used in general English as a synonym for “WLAN” as a popular name for a “wireless local area network” that uses one of the IEEE 802.11 standards.

Wi-Fi networks are built using one or more wireless routers called Access Points. The WiFi network can be connected to the larger Internet through an Access ISP using DSL, cable modem, and other Internet access technologies.

A device that can use Wi-Fi (such as a personal computer, video game console, smartphone, tablet, or digital audio player) can connect to a network resource such as the Internet via such an access point (or hot spot) acting as a wireless router. A hotspot is a site that offers Internet access over a wireless local area network acting as a router connected to a link to an Internet service provider. Hotspots typically use Wi-Fi technology.

In addition to telephony, modern mobile phones also support a wide variety of other services such as text messaging, MMS, e-mail, Internet access, short-range wireless communications (infrared, Bluetooth), business applications, gaming and photography. Mobile phones that offer these and more general computing capabilities are often referred to as smartphones. A hotspot application in a smart phone allows the smart phone's data connection to create a Wi-Fi network for multiple devices at once and smartphones with Wi-Fi radios can be used as wireless (or mobile) hotspots to connect Wi-Fi-enabled devices to a 3G or 4G Internet connection.

3G or 3rd generation mobile telecommunications is a generation of standards for mobile phones and mobile telecommunication services fulfilling the International Mobile Telecommunications-2000 (IMT-2000) specifications by the International Telecommunication Union. Application services include wide-area wireless voice telephone, mobile Internet access, video calls and mobile TV, all in a mobile environment.

4G is the fourth generation of cell phone mobile communications standards. It is a successor of the third generation (3G) standards. A 4G system provides mobile ultra-broadband Internet access, for example to laptops with USB wireless modems, to smartphones, and to other mobile devices. Two 4G candidate systems are commercially deployed, i.e. The Mobile WiMAX standard (at first in South Korea in 2006), and the first-release Long Term Evolution (LTE) standard (in Scandinavia since 2009). It has however been debated if these first-release versions should be considered as 4G or not since they do not satisfy the technical requirements adopted for 4G. 4G LTE, is a standard for wireless communication of high-speed data for mobile phones and data terminals. The standard is developed by the 3GPP (3rd Generation Partnership Project) and is specified in its Release 8 document series, with minor enhancements described in Release 9.

As smartphones can be connected as hot spots to the 3G or 4G Internet connection, a full Internet access can be made on any place. A mobile hotspot can therefore be seen as a little battery-powered Wi-Fi base station acting as a WiFi hotspot.

A mobile hotspot can have a full suite of security tools, including wireless security and a set a password to make it safe from hackers and freeloaders.

A phone can e.g. be tethered to a computer laptop via different technologies, such as e.g. by a Universal Serial Bus (USB), Bluetooth or Near Field Communication (NFC). A mobile hotspot device, such as a MiFi, is a further alternative for connection to a computer, but also means another device to carry.

Wireless USB is a short-range, high-bandwidth wireless radio communication protocol. Universal Serial Bus (USB) is an industry standard that defines the cables, connectors and communications protocols used in a bus for connection, communication and power supply between computers and electronic devices. In computer architecture, a bus is a subsystem that transfers data between components inside a computer, or between computers.

Near field communication (NFC) is a set of standards for smartphones and similar devices to establish radio communication with each other by touching them together or bringing them into close proximity, usually no more than a few centimetres. Present and anticipated applications include contactless transactions, data exchange, and simplified setup of more complex communications such as Wi-Fi. NFC standards cover communications protocols and data exchange formats, and are based on existing radio-frequency identification (RFID) standards.

MiFi is a line of compact wireless routers produced by Novatel Wireless that act as mobile Wi-Fi hotspots. MiFi stands for ‘My Wi-Fi’. The MiFi can be connected to a mobile phone (cellular) carrier and provide internet access for up to 5 devices.

Cars of today are equipped with a lot of electronic and other devices for control and communication.

Computers are installed in vehicles for controlling their function. Versatile car computers have data systems with features including navigation, tracking, data capture, on-site printing and sometimes even high speed 3G internet access.

Handsfree functions for mobile phones are obligatory in many countries for use of a mobile phone while driving and therefore they are often installed in cars. Handsfree describes equipment that can be used without the use of hands (for example via voice commands) or, in a wider sense, equipment which needs only limited use of hands, or for which the controls are positioned so that the hands are able to occupy themselves with another task (such as driving)

Devices that are typically used for handsfree communication usually use Bluetooth as its wireless technology. They still require a mobile phone or other device to initiate a call. Bluetooth handsfree options are found in any high end automotive as part of a vehicle's or other stereo system units. This option utilizes the vehicle's speakers to transmit the caller's voice in the phone call and have an embedded microphone in the stereo unit itself, the steering wheel, or use a separate wired microphone that can be placed anywhere in the vehicle.

Bluetooth is a proprietary open wireless technology standard for exchanging data over short distances (using short-wavelength radio transmissions from fixed and mobile devices, creating networks with high levels of security. It can connect several devices, overcoming problems of synchronization.

The Bluetooth standard involves the process of set up for identifying approaching devices and building the connections with identified devices. Any device may perform an inquiry to find other devices to connect to, and any device can be configured to respond to such inquiries. However, if the device trying to connect knows the address of the device, it always responds to direct connection requests and transmits the information shown in a list if requested. Use of a device's services may require pairing or acceptance by its owner, but the connection itself can be initiated by any device and held until it goes out of range. For security reasons it is necessary to be able to recognize specific devices and thus enable control over which devices are allowed to connect to a given Bluetooth device. At the same time, it is useful for Bluetooth devices to be able to establish a connection without user intervention (for example, as soon as they are in range). To resolve this conflict, Bluetooth uses a process called bonding, and a bond is created through a process called pairing. The pairing process is triggered either by a specific request from a user to create a bond (for example, the user explicitly requests to “Add a Bluetooth device”), or it is triggered automatically when connecting to a service where (for the first time) the identity of a device is required for security purposes. These two cases are referred to as dedicated bonding and general bonding respectively. A device that wants to communicate only with a bonded device can authenticate the identity of the other device, and so be sure that it is the same device it previously paired with. Bluetooth services generally require either encryption or authentication.

There exist solutions for interconnections in a car, including Internet connections.

Some car manufacturers build in a modem in the car for internet data exchange, which is not a very successful solution since it is very complicated for the user, since the user needs to manage a separate subscription for the modem that uses a dial-up connection for the access to Internet.

Many in-car internet systems use mobile phone networks to provide internet service. Wireless routers use mobile networks to provide WiFi in the car. In-car internet is an increasingly popular feature, and according to a study by market researcher Invensity, by the year 2013, every new car built in Europe will in the future be equipped with Internet connection. However, some technology writers speculate that the feature will not be popular as customers simply want to use smartphones to connect to the internet rather than pay extra for in-car internet services

A vehicle based wireless router can let any Wi-Fi equipped mobile phone access the internet from within the vehicle while travelling. Multiple devices can connect to the router at the same time, allowing several mobile phones to access the router's internet connection simultaneously. High speed internet access will be available whenever the vehicle is within a covered third generation 3G telecommunication area.

US2008/0229369 presents a multimedia communicator with a plurality of input sources and interfaces. A connection to the Internet via WiFi and connections to standard car interface audio/data systems are mentioned as possibilities but no solutions for establishing such connections are presented.

In WO2005/109988, a mobile device can connect via a cable to a microphone/speaker headset or establish a wireless communication session with a hands-free speaker system over a Bluetooth connection or other radio frequency operated connection. A mobile device communicates with a network device in a network that can be the Internet. There is an application in the mobile device that determines that a session can be established between the mobile device and a preferred network device. The publication enables a connection possibility for a hands-free system over a mobile device with a connection to internet.

US20020173347 presents a system for identifying a mobile terminal approaching a vehicle and connecting the hands-free unit of the vehicle to the mobile terminal upon an ignition switch being turned on by automatically transmitting a paging signal to page a mobile terminal. When a wireless communication unit in the system, that comprises the hands-free unit, receives a response from the mobile terminal, the system wirelessly connects the hands-free unit to the mobile terminal transmitting the response signal.

US20070142024 discloses a wireless adaptor establishing a wireless connection with a cellular phone and an additional one-way wireless connection with an available radio component in a car audio system.

The object of this invention is a user-friendly method to establish an internet connection for the data system of a vehicle.

### SUMMARY OF THE INVENTION

The method of the invention for connection in a telecommunication network comprises a mobile terminal with functionality for providing wireless access to a public network via an access point and with means for connection to a hands-free unit, a data system and a public network. The method comprise the steps of connecting the mobile terminal to said hands-free unit and automatically connecting the data system of the car to the mobile terminal upon the connection of the mobile terminal to the hands-free unit. The mobile terminal connects the data system to the public network over a wireless data exchange connection used by the mobile terminal for wireless access to the public network.

The system of the invention is mainly characterized in that the hands-free unit and the user terminal has means for connecting to each other, and in that the mobile terminal further comprises an application with means for activating the functionality for wireless network access upon connecting to the hands-free unit and for connecting the data system to the public network over a wireless data exchange connection used by the mobile terminal for wireless access to the public network.

The mobile terminal of the invention has functionality for providing wireless access to a public network via an access point by acting as a router to the public network. The mobile terminal comprises an application for connection to a hands-free unit, and an application for said functionality with means for being activated as a result of a connection having been established between the hands-free unit and the mobile terminal.

Preferred embodiments are presented in the sub claims.

The connection of the mobile user terminal to the hands-free system is preceded by a step in which the hands-free system of the hands-free unit identifies the approaching mobile terminal, which preferably takes place wirelessly e.g. by means of a Bluetooth pairing process or Radio-frequency identification (RFID) when using Near field communication (NFC).

RFID uses radio-frequency electromagnetic fields to transfer data from a tag attached to an object, for the purposes of automatic identification and tracking.

The identification step is followed by a handshake when using Bluetooth or it is followed by Near Field Communication (NFC) in order to dynamically set parameters of the communication channel to be established between the mobile terminal and a hands-free unit having a hands-free system.

Near field communication (NFC) is a set of standards for smartphones and similar devices to establish radio communication with each other by touching them together or bringing them into close proximity, usually no more than a few centimeters. Present and anticipated applications include contactless transactions, data exchange, and simplified setup of more complex communications such as Wi-Fi. NFC standards cover communications protocols and data exchange formats, and are based on existing radio-frequency identification (RFID) standards.

The invention is primarily meant to be used with a hands-free system in a hands-free unit of a vehicle, especially a car, wherein it is expected to be particularly useful. It can however, equally well be used together with a hands-free system of a boat, motor bike, tractor or other vehicle. The hands-free system can, however, be situated in any place and the place of the hands-free unit is not restricted to hands-free systems in vehicles.

A Bluetooth enabled mobile terminal intrinsically comprises a hands-free functionality.

In this text, the hands-free unit can be a completely separate unit not connected to the data system of the car at all or it can be connected to it or even functionally integrated with it.

Neither is the way of triggering the identification and handshake process of the hands-free function important for the effect of the invention itself. The process might be started by the user turning the ignition of the vehicle on, which causes a signal to be transmitted to the hands-free system in the hand-free unit in order to set up a wireless link between the hands-free unit and the mobile terminal. The process of the hands-free function can also be started by e.g. the opening of the door of the vehicle or the hands-free system might even be on all the time or be put on manually.

One of the key features of the invention is that the hot spot functionality of the terminal is activated upon the connection of a mobile user terminal to a hands-free system.

The data system is automatically connected to the mobile terminal when the application of the mobile terminal has started (or activated) the hot spot functionality. The data system periodically scans for known WLANs and when the WLAN provided by the mobile terminal appears, a connection is established to it.

The hands-free system can be integrated with the data system of the car in which case it is possible to design the process so that the hand-free function starts the WLAN connection, which might make the connection establishment faster.

The hot spot functionality is a feature to turn a mobile terminal, like a smartphone into a wireless hotspot. A mobile terminal with this functionality can be wirelessly tethered to allow users to apply their 3G or 4G signal to an additional connected device.

Said Hands-free handshake or Near Field Communication (NFC) can be used for the triggering of the Hot Spot functionality.

The triggering or activation of the hot spot functionality connects the data system of the car automatically to the mobile terminal over a wireless data exchange connection used by the mobile terminal. This takes place by means of the WLAN connection provided by the Hot Spot functionality.

The data system of the car is then connected to the internet or other public network by using the wireless network access point (hot spot) functionality using a conventional wireless data exchange connection (wifi). In the set up of the connection, the mobile terminal establishes a 3G or 4G packet data connection to the Internet through an Internet Service Provider (ISP) acting as an IP router. The mobile terminal itself acts as a router between the data system and the internet by being in the form of an access point (Hot Spot). The data system of the car can now communicate with and use Internet Services over a mobile terminal such as a mobile phone.

Instead or besides using the invention for internet access, the data system can in some embodiments be connected to another public network, such as to a network of some organization, like the police, a rescue function, or the army. Thus the term public network is meant to cover all kinds of intranets in addition to open public networks now and in the future in addition to the Internet even if the intranets would not be open for people outside the organization in question.

A mobile telephone or terminal is often connected to a USB cable in a car for charging of the battery of the phone and a USB cable could be used as the data communication connection instead of a wireless WiFi hotspot. The use of the hotspot functionality according to the invention is, however, a more practical solution since then the user does not need to even touch the telephone or terminal to start using the functionality when coming to the vehicle. A central approach in the branch of developing user solutions is for the time being to avoid the need of actions form the user side.

In this way, also the data connection can automatically be kept updated along with newer and faster network technologies coming to the market along with the user updating the mobile device.

Next, the invention is described by means of some advantageous embodiments by means of figures. The invention is not restricted to the details of these embodiments.

### FIGURES

FIG. 1 is an architecture view of an environment in which the invention can be implemented

FIG. 2 is a flow scheme of an embodiment of the invention

### DETAILED DESCRIPTION

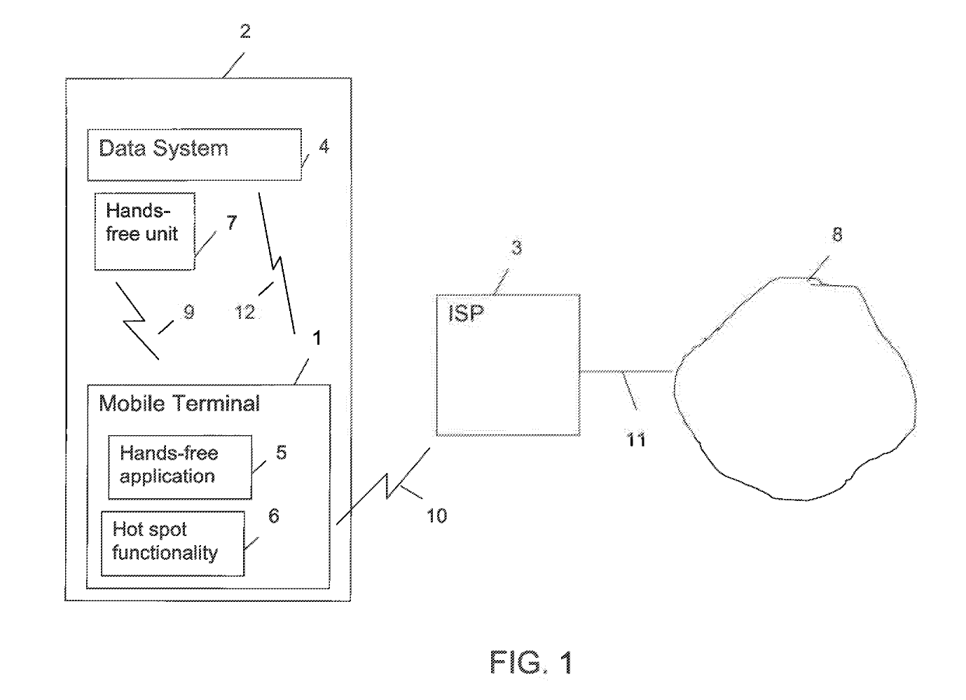

FIG. 1 is an architecture view of a first environment in which the invention can be implemented. In this embodiment, the invention is used in a car having a computer with a data system for different control and other functions.

A mobile terminal 1, such as a smart phone, that supports Internet access, is used in a car 2 for providing Internet access for the data system 4 in the car 2.

A connection to Internet is needed to the data system 4 to make it possible for it to make use of Internet services in the car.

The mobile terminal 1 also supports short-range wireless communications, like Bluetooth, which is used to establish a connection between the mobile terminal 1 and a hands-free unit 7 in the car. The mobile terminal 1 and the data system 4 constitute a Wireless Local Area Network (WLAN) connection 12 when connected. The mobile terminal 1 has an application 5 for the hands-free connection between the hands-free unit 7 and the mobile terminal 1.

Furthermore, the mobile terminal 1 has an application 6 for hot spot functionality in order to build up a WLAN (or WiFI) and can therefore be used as a wireless hotspot (or router) to connect the data system to a 3G or 4G Internet connection 10.

When the hot spot functionality of the mobile terminal 1 has been activated and the mobile terminal 1 has been connected to the hands-free unit 7 of the car 2, the data system 4 is connected to the Internet 8 via the mobile terminal acting as a hot spot and further through an Internet Service Provider (ISP) 3 connected 11 to the Internet which ISP in practice is an IP router of e.g. a telecommunication operator serving the mobile terminal 1 that acts as a wireless WiFi router for the data system 4.

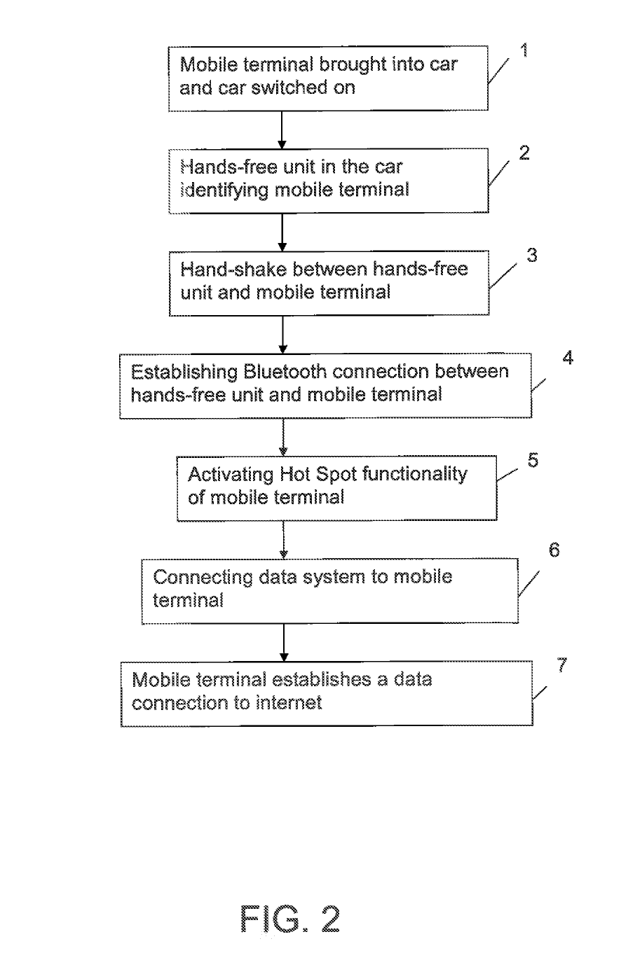

FIG. 2 is a flow scheme of the first embodiment of the invention.

It is assumed that in step 1 of FIG. 2, a user with a mobile terminal having a hands-free functionality comes into a car with a data system also having a hands-free functionality. The hands-free function in the car might be on already or is started manually or automatically upon e.g. opening the door or turning the ignition of the car on.

Next, the hands-free system of the hands-free unit identifies the mobile terminal in step 2 by e.g. Bluetooth pairing technology or RFID used by NFC technology.

A wireless link for the hands-free function between the hands-free unit and the mobile terminal can be set up through a handshake process described in step 3 being an automated process of negotiation that dynamically sets parameters of the communication channel established between these two entities before normal communication over the channel begins. It follows the physical establishment and the technique of communication of the channel and precedes normal information transfer. Handshake is part of e.g. Bluetooth technology.

Step 4 establishes a Bluetooth connection between the hands-free unit and the mobile terminal.

The mobile terminal has an application for hot spot functionality, which is designed to be activated in step 5 upon the above connection having been established between the hands-free unit and the mobile terminal. The hotspot functionality is e.g. triggered by the handshake process.

The activation of the hot spot functionality connects the data system of the car to the mobile terminal in step 6 over a wireless data exchange connection used by the mobile terminal. This takes place by means of the WLAN connection provided by the Hot Spot functionality.

In step 7, the mobile terminal establishes a 3G or 4G packet data connection to the Internet via an Internet Service Provider (ISP) acting as an IP router. The mobile terminal itself acts as a router between the data system and the internet in the form of an access point (Hot Spot). The data system is now can now communicate with and use Internet Services.

1. A method for connection in a telecommunication network that comprises a mobile terminal with a functionality for providing wireless access to a public network via an access point and with means for connecting to a hands-free unit, a data system and a public network, the method comprising:
a) connecting the mobile terminal to said hands-free unit,
b) automatically connecting the data system to the mobile terminal upon the connection of the mobile terminal to the hands-free unit,
c) the mobile terminal connecting the data system to the public network over a wireless data exchange connection used by the mobile terminal for wireless access to the public network.

2. The method of claim 1 wherein the connecting of step a) is preceded by the hands-free unit identifying the mobile terminal as a result of which the connection is set up.

3. The method of claim 2 wherein a Bluetooth System connection is used in the transmission link between the hands-free unit and the mobile terminal, whereby the identification is performed by pairing the hands-free unit and the mobile terminal, which utilizes a handshake for setting up the connection.

4. The method of claim 2 wherein a Near Field Communication (NFC) is used for the connecting of the hands-free unit to the mobile terminal, whereby Radio Frequency IDentification (RFID) is used for the identification of the mobile terminal.

5. The method of claim 1 wherein the functionality for providing wireless access to a public network via an access point is a hot spot functionality, which is activated in step b) as a result of the connection to the hands-free unit.

6. The method of claim 5 wherein step b) takes place by connecting the data system to the mobile terminal by means of a WLAN connection provided by the hot spot functionality for wireless access to the public network.

7. The method of claim 6 wherein the mobile terminal establishing a data connection to the Internet via an Internet Service Provider ISP in step c).

8. The method of claim 1 wherein the data system and the hands-free unit are in a vehicle.

9. The method of claim 1 wherein the public network is the Internet.

10. A system for connection in a telecommunication network that comprises a mobile terminal with a functionality for providing wireless access to a public network and with means for connecting to a hands-free unit, a data system and a public network, comprising:
a) the hands-free unit and the mobile terminal have means for connecting to each other, and
b) the mobile terminal further comprises an application with means for activating the functionality for wireless network access upon connecting to the hands-free unit and for connecting the data system to the public network over a wireless data exchange connection used by the mobile terminal for wireless access to the public network.

11. The system of claim 10 wherein the hands-free unit utilizes a Bluetooth System connection in the transmission link between the hands-free unit and the mobile terminal.

12. The system of claim 10 wherein the data system and the hands-free unit are in a vehicle.

13. The system of claim 10 wherein the public network is the Internet.

14. The system of claim 10 wherein the hands-free unit has means for identifying the mobile terminal.

15. The system of claim 10 wherein the functionality for wireless access to a public network consists of a hotspot functionality, whereby the mobile terminal is a wireless router acting as a hot spot access point for the data system when connected to the public network.

16. A mobile terminal having a functionality for providing wireless access to a public network via an access point by acting as a router to the public network, and comprising:
an application for connection to a hands-free unit, and
an application for said functionality with means for being activated as a result of a connection having been established between the hands-free unit and the mobile terminal.

17. The mobile terminal of claim 16, wherein said functionality is a hot spot functionality.
